(19) United States
(12) Patent Application Publication
(10) Pub. No.: US 2023/0130747 A1
(43) Pub. Date: Apr. 27, 2023

(54) COMPUTER-READABLE RECORDING MEDIUM STORING LEARNING PROGRAM, LEARNING METHOD, AND INFORMATION PROCESSING DEVICE

(71) Applicant: FUJITSU LIMITED, Kawasaki-shi (JP)

(72) Inventor: Masafumi YAMAZAKI, Tachikawa (JP)

(73) Assignee: FUJITSU LIMITED, Kawasaki-shi (JP)

(21) Appl. No.: 17/869,803

(22) Filed: Jul. 21, 2022

(30) Foreign Application Priority Data
Oct. 21, 2021 (JP) 2021-172496

(51) Int. Cl. G06N 3/08

(52) U.S. Cl. CPC G06N 3/08

(57) ABSTRACT

A procedure includes extracting a divisible layer among a plurality of layers included in a machine learning model, based on a definition of the machine learning model and information regarding a machine learning execution environment that includes information regarding a plurality of calculation nodes that performs machine learning by using the machine learning model, and determining a division type and a number of divisions that are available in each extracted divisible layer, obtaining an operation amount for each of the calculation nodes, based on the division type and the number of divisions, obtaining a communication cost and an operation cost of the machine learning model after division of the divisible layer, based on the division type and the number of divisions, and presenting the operation amount, the communication cost, and the operation cost.

### CROSS-REFERENCE TO RELATED APPLICATION

This application is based upon and claims the benefit of priority of the prior Japanese Patent Application No. 2021-172496, filed on Oct. 21, 2021, the entire contents of which are incorporated herein by reference.

### FIELD

The embodiments discussed herein are related to a learning program, a learning method, and an information processing device.

### BACKGROUND

In recent years, implementation of artificial intelligence (AI) technologies has been rapidly advanced in various fields, and for example, studies regarding deep learning (DL) among the above technologies have been actively conducted. The deep learning technology has been further implemented by being expanded from an image to identification of languages and time-series data. For example, studies regarding deep learning for executing processing such as recognition and understanding of content of an image, sound, a sentence, or the like have been conducted.

Here, application development including deep learning technology using a deep neural network (DNN) roughly includes the following processes. For example, there are processes such as deep neural network model design, learning data preparation, learning processing and result confirmation, and incorporation of an application of a machine learning model after learning. Hereinafter, the deep neural network is also simply called a neural network.

Here, from the past to recent years, various deep learning platforms have been provided from various companies, universities, or the like. In the deep learning platform that has been typically provided, development is often facilitated, for example, in a form of open source software (OSS), and a function expansion speed is significantly high. Due to such development based on the OSS, inference processing has been applied to various products. However, in learning processing specialized in large-scale environments that require an increase in size or speed, it is difficult to achieve benefits of development caused by open-sourcing.

Furthermore, in recent years, in the deep learning field, a DNN learning integration environment, for developers to more easily and integrally perform change of a neural network configuration, capturing and management of learning data, and execution of learning and management of learning results, has been put into practical use. For example, in one of the existing DNN learning integration development environments, it is possible to design a neural network on a graphical user interface (GUI), perform automatic tuning of the neural network, start learning processing on a screen and confirm a learning status, and manage a learning history. In this DNN learning integration development environment, learning coping with data parallel with a plurality of nodes may be performed using a central processing unit (CPU) and a graphics processing unit (GPU). In addition, there is a DNN learning integration development environment that enables seamless use of on-premises and a cloud, job inputs, and secure data management.

Here, in deep learning, learning processing using a neural network including a large number of layers and large-scaled data is executed. Therefore, it is significantly important to accelerate the learning processing. In recent learning processing in deep learning, parallel learning using a large number of computers is generally performed. For example, in order to develop a more accurate and highly functional neural network model, large-scale learning processing using a large-scale machine learning model and large-scale data is required. Then, more resources are used for large-scale learning. Therefore, as a technology for efficiently using a large number of calculation resources, methods such as data parallel and model parallel are proposed.

The data parallel is a division method for dividing the number of pieces of input data of a layer. In a case where the data parallel is performed, in the learning processing, after forward processing and backward processing, communication and operations for gradient information aggregation processing are additionally performed. Furthermore, the model parallel is a method for reducing an operation amount in node unit by dividing input data or dividing a weight parameter. In the model parallel, an operation amount caused by communication and aggregation that are additionally performed according to a type of division changes. Hereinafter, the division by the data parallel and the division by the model parallel are collectively referred to as model division.

Japanese Laid-open Patent Publication No. 2018-55570 is disclosed as related art.

### SUMMARY

According to an aspect of the embodiments, a non-transitory computer-readable recording medium storing a learning program for causing a computer to execute a procedure, the procedure includes extracting a divisible layer among a plurality of layers included in a machine learning model, based on a definition of the machine learning model and information regarding a machine learning execution environment that includes information regarding a plurality of calculation nodes that performs machine learning by using the machine learning model, and determining a division type and a number of divisions that are available in each extracted divisible layer, obtaining an operation amount for each of the calculation nodes, based on the division type and the number of divisions, obtaining a communication cost and an operation cost of the machine learning model after division of the divisible layer, based on the division type and the number of divisions, and presenting the operation amount, the communication cost, and the operation cost.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a model design assistance device according to a first embodiment;

FIG. 2 is a configuration diagram of an example of an information processing system that executes deep learning;

FIG. 3 is a diagram illustrating an example of a parallelization method in a case of a convolution layer;

FIG. 4 is a diagram illustrating a flow of an example of learning processing in a case where parallel processing is executed;

FIG. 5 is a diagram illustrating an example of communication occurred in the learning processing in a case where the parallel processing is executed;

FIG. 6 is a diagram of an example of a notification screen of a layer to be a bottleneck of division;

FIG. 7 is a flowchart of learning processing of deep learning using the model design assistance device according to the first embodiment;

FIG. 8 is a flowchart of model design processing by the model design assistance device according to the first embodiment;

FIG. 9 is a diagram illustrating an example of an information processing system in which a deep neural network according to a third embodiment operates;

FIG. 10 is a diagram illustrating an example of communication occurred in learning processing in a case where parallel processing is executed in the third embodiment;

FIG. 11 is a block diagram of a model design assistance device according to a fourth embodiment;

FIG. 12 is a flowchart of model design assistance processing by the model design assistance device according to the fourth embodiment; and

FIG. 13 is a hardware configuration diagram of a model design assistance device.

### DESCRIPTION OF EMBODIMENTS

There are a large number of model division methods for performing deep learning using a neural network at high speed. In order to execute learning processing at high speed, it is required to select an optimum division method according to a shape of a neural network model from among a large number of model division methods. However, because a large number of communication or the like occurs due to division, acceleration by the model division is limited. Furthermore, by dividing the neural network model, costs for calculation for communication and integration are incurred. Therefore, after assuming learning after the division, design of a neural network model that is more suitable for division is required.

Note that, as a division technology in the neural network, for example, in a camera or the like, there is a technology for paying attention to a feature data amount and an operation amount, evaluating a communication amount as a memory amount received from another computing unit, and selecting division according to a limit of the memory amount so as to execute inference processing.

However, a typical neural network model division method selects a division method by a developer on the basis of experiences, causes a machine learning device to perform learning after reflecting the selected division method on a model definition in advance, and determines a division method to be adopted on the basis of the learning result. In this way, in the model division dependent on the experience of the developer, it is difficult to easily specify optimum model division, and it takes time to reach the optimum model division. Therefore, it is difficult to accelerate learning processing by designing an optimum neural network model.

Furthermore, the technology for selecting division using the feature data amount, the operation amount, and the memory amount as the communication amount so as to execute the inference processing does not consider communication performances such as a latency and a bandwidth, and it is difficult to accelerate the learning processing by the design of the optimum neural network model in consideration of the cost.

Hereinafter, embodiments of a technology that accelerates learning processing will be described in detail with reference to the drawings. Note that a learning program, a learning method, and an information processing device disclosed in the present application are not limited to the following embodiments.

### First Embodiment

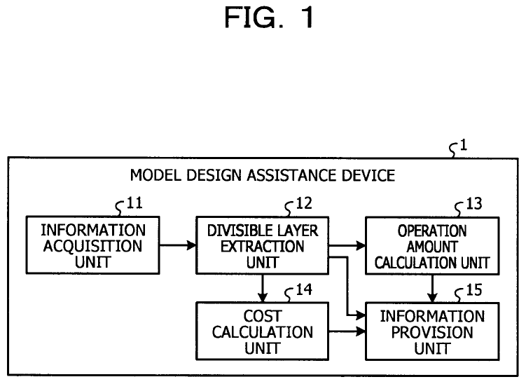

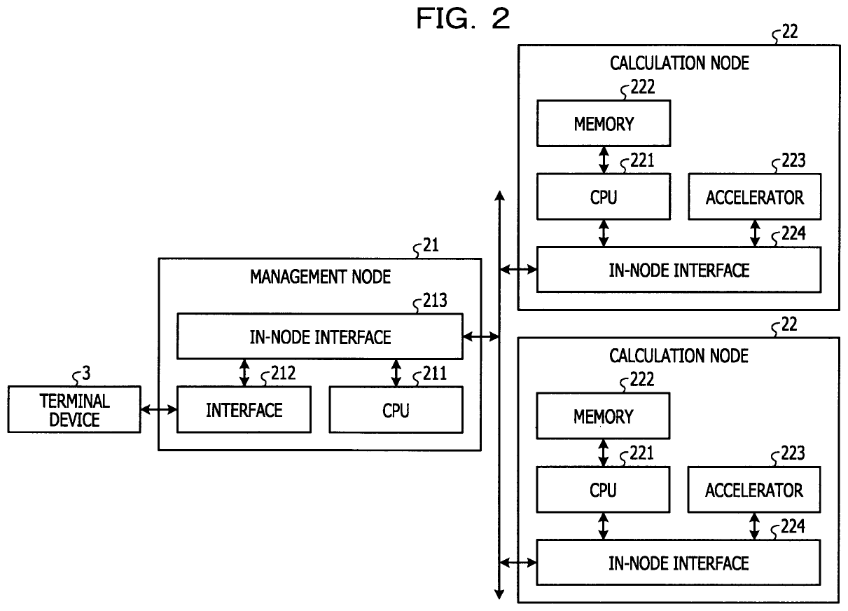

FIG. 1 is a block diagram of a model design assistance device according to a first embodiment. A model design assistance device 1 is an information processing device that assists design of a neural network model that is a machine learning model used for deep learning. FIG. 2 is a configuration diagram of an example of an information processing system that executes deep learning. In a deep learning system that performs deep learning using a neural network that is a design assistance target of the model design assistance device 1 according to the present embodiment, a management node 21, a plurality of calculation nodes 22, and a terminal device 3 are arranged.

The management node 21 includes a CPU 211, an interface 212, and an in-node interface 213. The interface 212 is a communication interface with an external device and is connected to the terminal device 3, for example. Furthermore, the in-node interface 213 is connected to the calculation node 22 via a high-speed network. The CPU 211 communicates with the terminal device 3 via the in-node interface 213. Furthermore, the CPU 211 communicates with the other calculation node 22 via the in-node interface 213.

The management node 21 receives an input of information regarding a designed neural network model from the terminal device 3. Moreover, in a learning phase, the management node 21 receives an input of information regarding learning data used for learning and a learning job from the terminal device 3. Then, the management node 21 arranges the learning job and inputs the learning data into the calculation node 22 on the basis of the acquired neural network model. Furthermore, in an inference phase, the management node 21 receives an input of operation data from the terminal device 3. Then, the management node 21 inputs the operation data into the calculation node 22 that forms a learned neural network model. These functions of the management node 21 are implemented by the CPU 211.

Each calculation node 22 includes a CPU 221, a memory 222, an accelerator 223, and an in-node interface 224. The calculation node 22 may mount the plurality of CPUs 221. Furthermore, the calculation node 22 may mount the plurality of accelerators 223. The in-node interface 224 is connected to the other calculation node 22 and the management node 21 via a high-speed network.

The CPU 221 receives an input of information regarding a job to be executed and learning data used for deep learning from the management node 21 in the learning phase. Then, the CPU 221 makes the memory 222 hold the learning data and sequentially inputs the learning data stored in the memory 222 into the accelerator 223 so as to execute a designated job. Furthermore, in the inference phase, the CPU 221 inputs the operation data input from the management node 21 into the accelerator 223.

The accelerator 223 mounts a GPU. Then, the accelerator 223 executes learning processing of deep learning by executing the designated job on the learning data given from the CPU 221. Furthermore, the accelerator 223 executes inference processing of deep learning by executing the designated job on the operation data given from the CPU 221.

The accelerator 223 according to the present embodiment forms a convolutional neural network having a large number of neurons. Then, each layer of the convolutional neural network executes forward processing for recognizing input data using a weight parameter. Output data from each layer is input data of a next layer. At the time of the learning processing, thereafter, each layer of the convolutional neural network executes backward processing for calculating gradient information while propagating difference information in a backward direction and update processing for updating the weight parameter using the gradient information. At the time of the learning processing, the convolutional neural network repeatedly executes a large number of learning processing cycles including the forward processing, the backward processing, and the update processing. At the time of the inference processing, the convolutional neural network performs recognition through the forward processing and outputs a recognition result.

The terminal device 3 is an information processing device used by a user of the deep learning system. The user inputs the information of the designed neural network model into the management node 21 using the terminal device 3. Moreover, in the learning phase, the user inputs the information regarding the learning data used for learning and the learning job into the management node 21 using the terminal device 3. Furthermore, in the inference phase, the user inputs the operation data into the management node 21 using the terminal device 3. As a result, the user makes the calculation node 22 execute the designated job and perform deep learning, via the management node 21.

Returning to FIG. 1, details of the model design assistance device 1 that assists to design the neural network model of the deep learning system illustrated in FIG. 2 will be described. The model design assistance device 1 includes an information acquisition unit 11, a divisible layer extraction unit 12, an operation amount calculation unit 13, a cost calculation unit 14, and an information provision unit 15.

The information acquisition unit 11 reads a neural network model definition created by a designer of the neural network model from an external device (not illustrated). In the neural network model definition, information indicating how each layer executes what type of processing is registered. For example, for one layer, information indicating that the layer is a convolution layer, the number of input channels, a kernel size, the number of output channels, or the like are registered. Furthermore, as for the number of data parallels, the number defined by the designer in advance is registered in the neural network model definition.

Furthermore, the information acquisition unit 11 reads information regarding a learning execution environment in the learning system illustrated in FIG. 2 from an external device (not illustrated). In the information regarding the learning execution environment, the number of execution nodes, the number of processes per calculation node 22, the number pieces of data per process number, an inter-node communication latency, an inter-node communication bandwidth, or the like are registered. The inter-node communication latency is a response speed between the calculation nodes 22. Furthermore, the inter-node communication bandwidth is a band representing how much data is continuously flowed when a large amount of data is continuously sent.

Then, the information acquisition unit 11 outputs the acquired neural network model definition and information regarding the learning execution environment to the divisible layer extraction unit 12.

The divisible layer extraction unit 12 receives the input of the information regarding the neural network model definition and the learning execution environment from the information acquisition unit 11. Then, the divisible layer extraction unit 12 extracts a divisible layer to be divided from the neural network model and determines a usable division type and the number of divisions for each divisible layer. The divisible layer extraction unit 12 may assume all the layers in the neural network model as the divisible layers.

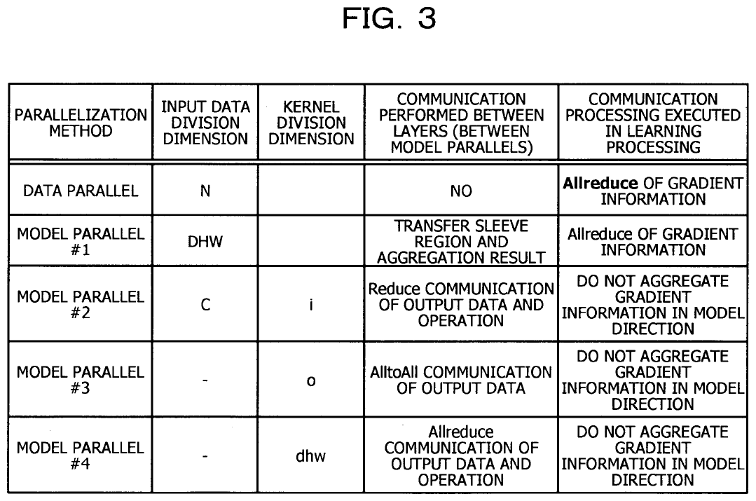

For example, the divisible layer extraction unit 12 determines the division type according to a combination of a dimension type of a data tensor acquired from the neural network model definition and a dimension type of a kernel tensor. FIG. 3 is a diagram illustrating an example of a parallelization method in a case of a convolution layer. For example, the divisible layer extraction unit 12 selects a parallelization method corresponding to a combination of a divisible dimension type of a data tensor of input data and a divisible dimension type of a kernel tensor from among the parallelization methods illustrated in FIG. 3 and determines to use the selected parallelization method as a division type.

Various parallelization methods in FIG. 3 will be briefly described. The data parallelism is a parallelization method for dividing N that is a size of the data kernel into a plurality of pieces.

A model parallel #1 is a parallelization method for performing division in each dimensional direction of input data. For example, in a case where the input data is three-dimensional data, division is performed in each dimensional direction indicated by DHW. In a case of the model parallel #1, although each calculation node 22 has input data having an amount of one model parallel, each calculation node 22 uses information in a sleeve region of a next calculation node 22 by a half of a kernel size for convolution operations. The sleeve region and an aggregation result of the output data are transferred between the calculation nodes 22 forming the model parallel #1.

Furthermore, a model parallel #2 is a parallelization method for performing division with C that is the number of input channels and is of the kernel. In a case of the model parallel #2, the calculation node 22 has only input data for some channels. Therefore, for a tensor output from each calculation node 22, Reduce communication and operation to aggregate data for the divided channels, in the results of all the calculation nodes 22 that have performed the model parallel, are performed. However, in the model parallel #2, gradient information in a model direction is not aggregated.

Furthermore, a model parallel #3 is a parallelization method for performing division with oc of a kernel. In a case of the model parallel #3, because each calculation node 22 does not have only a kernel for a specific output channel, each calculation node 22 calculates a part divided by the model parallel. For the tensor output from each calculation node 22, AlltoAll communication is performed for an operation in a next layer. However, in the model parallel #3, the gradient information in the model direction is not aggregated.

Furthermore, a model parallel #4 is a parallelization method for performing division in each dimensional direction of the kernel. For example, in a case of a three-dimensional kernel, division in each of dimensional directions indicated by dhw is performed. Furthermore, in a case of a two-dimensional kernel, division in each of dimensional directions represented by hw is performed. In a case of the model parallel #4, because each calculation node 22 holds only a part of the kernel, communication and operations for Allreduce are performed on the results of the other calculation nodes 22 of the combination of the model parallels, regarding the tensor output from each calculation node 22. However, in the model parallel #4, the gradient information in the model direction is not aggregated.

Returning to FIG. 1, the description will be continued. The divisible layer extraction unit 12 acquires information regarding a size of input data and a size of output data of each layer, for example, from a definition of learning data or the like. Then, the divisible layer extraction unit 12 determines an upper limit of the number of divisions using a size that is the smaller one of the size of the input data and the size of the output data as a minimum size of data generated through division. For example, in a case where the size of the input data is 8×8×8 and the size of the output data is 4×4×4, the divisible layer extraction unit 12 determines the number of divisions having 4×4×4 as the minimum size of the data when division is performed as the upper limit of the number of divisions.

Thereafter, the divisible layer extraction unit 12 specifies a layer with the minimum number of divisions that may be used in each layer. Then, the divisible layer extraction unit 12 determines the number of divisions that may be used in the specified layer as the number of divisions that may be used in the entire neural network model. Then, the divisible layer extraction unit 12 outputs information regarding the division type used in each layer and the number of divisions that may be used in the entire neural network model to the operation amount calculation unit 13 and the cost calculation unit 14. For example, in a case where there is a plurality of numbers of divisions that may be used in the entire neural network model, information regarding the plurality of numbers of divisions is sent to the operation amount calculation unit 13 and the cost calculation unit 14. Moreover, the divisible layer extraction unit 12 outputs the information regarding the division type and the number of divisions that may be used in each layer to the information provision unit 15.

The operation amount calculation unit 13 receives an input of the information regarding the division type used in each layer and the number of divisions in the entire neural network model from the divisible layer extraction unit 12. Then, the operation amount calculation unit 13 calculates an operation amount in each layer in a case where model division is performed. For example, in a case of the convolution layer, the operation amount calculation unit 13 calculates an operation amount in each convolution layer using the following formulas (1) to (3).

$${a}_{ij}^{( k )} = {{\sum }^{m - 1}}_{s = 0} {{\sum }^{n - 1}}_{t = 0} {w}_{st}^{( k )} {x}_{( i + s ) ( j + t )} + {b}^{( k )} \qquad ( 1 )$$

$$\begin{matrix}\frac{\partial E}{\partial {w}_{st}^{( k )}} = {\sum }_{i = 0}^{M - m} {\sum }_{j = 0}^{N - n} \frac{\partial E}{\partial {a}_{ij}^{( k )}} \frac{\partial {a}_{ij}^{( k )}}{\partial {w}_{st}^{( k )}} \\ = {\sum }_{i = 0}^{M - m} {\sum }_{j = 0}^{N - n} \frac{\partial E}{\partial {a}_{ij}^{( k )}} {x}_{( i + s ) ( j + t )}\end{matrix} \qquad ( 2 )$$

$$\begin{matrix}\frac{\partial E}{\partial {x}_{ij}} = {\sum }_{s = 0}^{m - 1} {\sum }_{t = 0}^{n - 1} \frac{\partial E}{\partial {a}_{( i - s ) ( j - t )}^{( k )}} \frac{\partial {a}_{( i - s ) ( j - t )}^{( k )}}{\partial {x}_{ij}} \\ = {\sum }_{s = 0}^{m - 1} {\sum }_{t = 0}^{n - 1} \frac{\partial E}{\partial {a}_{( i - s ) ( j - t )}^{( k )}} {w}_{st}^{( k )}\end{matrix} \qquad ( 3 )$$

Here, the formula (1) is an operation used for the inference processing in the forward processing. Furthermore, the formula (2) is an operation used to calculate difference data in the backward processing. Furthermore, the formula (3) is an operation used for weight parameter gradient calculation using difference data of a previous layer in the backward processing. Here, in a case where model division is performed, an operation amount of one calculation node 22 is reduced.

In a case where there is a plurality of candidates for the number of divisions that may be used in the entire neural network, the operation amount calculation unit 13 calculates an operation amount in each layer for each number of divisions. Thereafter, the operation amount calculation unit 13 outputs the operation amount in each layer to the information provision unit 15.

The cost calculation unit 14 receives the input of the information regarding the division type used in each layer and the number of divisions in the entire neural network model from the divisible layer extraction unit 12. Then, the cost calculation unit 14 calculates a communication cost and an operation cost caused by communication occurred by performing division on the basis of the information regarding the data division and the information regarding the division type used in each layer and the number of divisions in the entire neural network model.

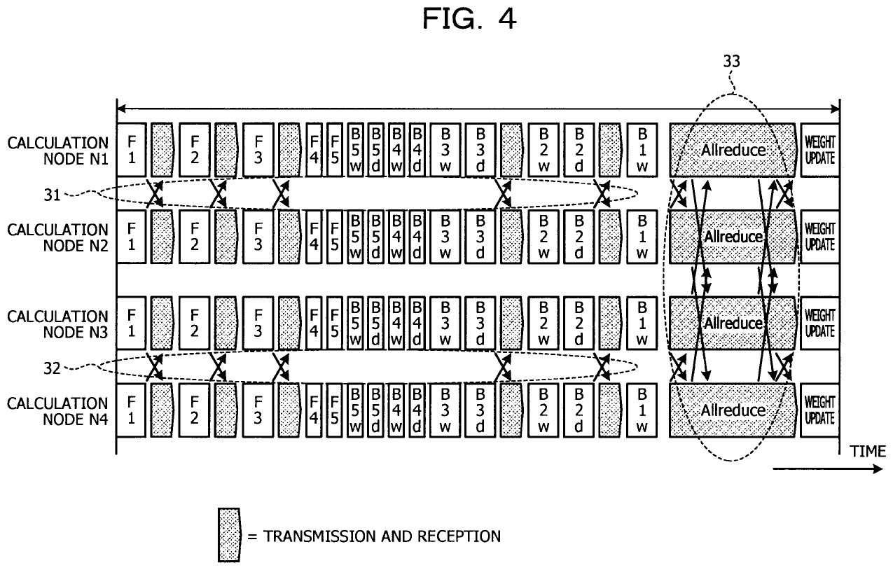

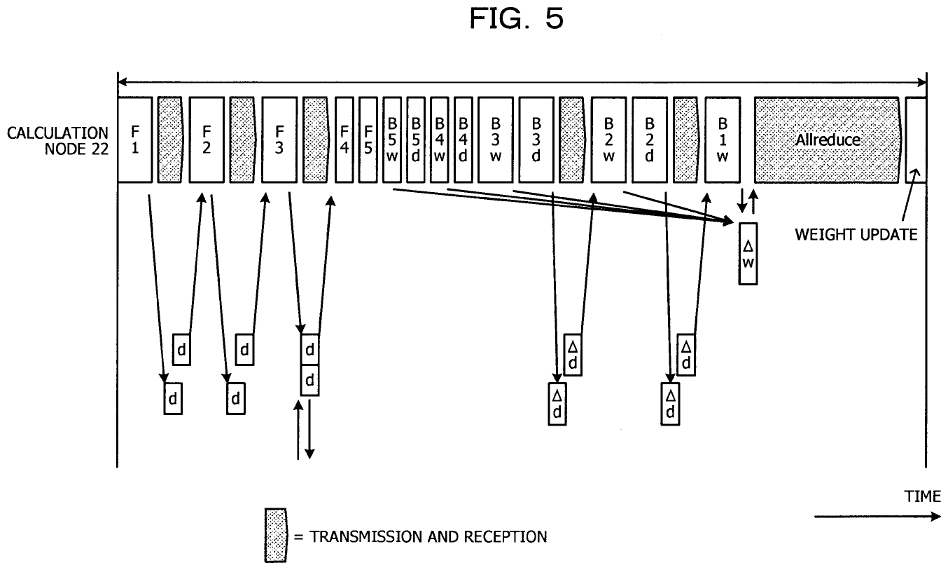

FIG. 4 is a diagram illustrating a flow of an example of learning processing in a case where parallel processing is executed. Furthermore, FIG. 5 is a diagram illustrating an example of communication occurred in the learning processing in a case where the parallel processing is executed. In both FIGS. 4 and 5, the vertical axis represents the calculation node 22, and the horizontal axis represents passage of time. Here, with reference to FIGS. 4 and 5, communication caused by communication occurred by performing division will be described.

In the learning processing, in an n-th layer, forward processing of the n-th layer indicated by Fn and backward processing of the n-th layer indicated by Bn are executed. The backward processing includes difference data calculation processing and weight parameter gradient calculation processing.

FIG. 4 illustrates learning processing in a case where a two-node model parallel and a two-division data parallel are used together. Nodes N1 and N2 execute processing for model-dividing one neural network model. Similarly, nodes N3 and N4 execute model parallel processing for dividing one neural network model. Furthermore, the nodes N1, N2, N3, and N4 respectively execute the data parallel processing for processing different pieces of data.

Communication associated with the model parallel is communication in the sleeve region (Halo) used for operations and data sharing (gather) communication between the two calculation nodes 22. These communications are communications 31 and 32 performed between the calculation nodes 22 included in a combination for executing the model parallel processing. Furthermore, for the gradient information calculated through the backward processing for calculating a weight parameter gradient in each layer, processing 33 is executed, which is called Allreduce and shared by all the calculation nodes 22, for sharing information aggregated by calculating an average value for each element obtained among all the calculation nodes 22. Allreduce is processing associated with the data parallel. Then, weight parameter update processing is executed using the result of Allreduce, and this is processing for one time of repeated learning processing. In deep learning, this repeated processing is repeated equal to or more than several thousands to several tens of thousands times until a desired performance is achieved. FIG. 4 represents the processing for one time of the repeated learning processing.

As illustrated in FIG. 5, there are two types of communication increased through division including communication for transmission and reception of data used for an operation in a next layer and communication used in aggregation processing by Allreduce. In FIG. 5, data transmitted and received in the forward processing is represented as d, and difference data and a weight parameter gradient transmitted and received in the backward processing are respectively represented as Δd and Δw. Because the communication for the transmission and reception of the data used for the operation in the next layer is communication associated with the model parallel and makes the next layer wait for being processed, communication processing is executed at the highest priority. Furthermore, the aggregation by Allreduce is collectively performed at a timing when all the weight parameter gradients are obtained. The larger the neural network, the greater the amount of the weight parameter. Furthermore, as the number of divisions increases, the aggregation processing needs more time.

As the learning processing, forward processing in each of layers F1 to F5 and backward processing in each of layers B1 to B5 are executed. Furthermore, in the learning processing, after the aggregation with respect to the weight parameter gradient by Allreduce output through the weight parameter calculation processing in the backward processing, weight update processing is executed.

Here, details of the calculation of the communication cost and the operation cost, caused by the communication occurred by performing division, performed by the cost calculation unit 14 will be described. Here, as a typical parameter, three-dimensional data will be described as an example.

In a case where the three-dimensional data is used, a shape of input data is a five-dimensional tensor. The input data is feature data output from the previous layer. A size of the input data that is the five-dimensional tensor is represented as NCDHW, which corresponds to a size for each dimension. N is a size in a batch direction and represents a batch size. Furthermore, C is a size in a channel direction and represents a channel size. Furthermore, DHW is a size of each dimension of the three-dimensional data and respectively represents sizes of a depth, a height, and a width of data.

Furthermore, in a case where the three-dimensional data is used, a shape of a kernel is also a five-dimensional tensor. A size of the kernel that is the five-dimensional tensor is represented as iodhw, which corresponds to a size for each dimension. The reference i is the number of input channels and is usually equal to the size C of the input data. The reference o is the number of output channels and is usually equal to the size C of the output data. Furthermore, dhw represents sizes of respective dimensions of the three-dimensional kernel and respectively represents sizes of a depth, a height, and a width of the kernel. Here, a case where the three-dimensional data is used has been described as an example. However, in a case where two-dimensional data is used, data and a kernel are four-dimensional tensors.

In this case, the cost calculation unit 14 calculates an operation cost in the convolution layer using the following formula (4).

$${Cost}_{conv , calc} = N ⨯ C ⨯ \frac{D ⨯ H ⨯ W}{{s}^{3}} ⨯ o ⨯ d ⨯ h ⨯ w \qquad ( 4 )$$

Here, Cost_{conv,clac} represents the operation cost of the convolution layer. Furthermore, s represents an interval between slides in the convolution layer.

Furthermore, the cost calculation unit 14 calculates a communication cost of the convolution layer using the following formulas (5) and (6).

$${Cost}_{conv , allreduce} = i ⨯ o ⨯ d ⨯ h ⨯ w ⨯ Nd ⨯ Nm \div B + L \qquad ( 5 )$$

$${Cost}_{conv , halo} = i ⨯ h ⨯ w ⨯ \frac{d}{2} ⨯ Nm \div B + L \qquad ( 6 )$$

Here, Cost_{conv,allreduce} in the formula (5) represents a communication cost of Allreduce in the convolution layer. Furthermore, Cost_{conv,halo} in the formula (6) represents a communication cost for transmission and reception in the sleeve region in the convolution layer in the model parallel. Furthermore, Nd represents the number of data parallels. Furthermore, Nm represents the number of model parallels. Furthermore, L represents a communication latency, and its unit is seconds. Furthermore, B represents a communication band, and its unit is byte/s. The cost calculation unit 14 assumes a sum of the communication cost of Allreduce in the convolution layer and the communication cost for transmission and reception in the sleeve region as the communication cost in the convolution layer.

In addition, in a case of a fully-coupled layer, the cost calculation unit 14 calculates an operation cost using the following formula (7).

Cost_{FC,calc}=N×i×o÷Nd (7)

Moreover, the cost calculation unit 14 can calculates a communication cost in the fully-coupled layer using the following formulas (8) to (10).

$${Cost}_{FC , allreduce} = i ⨯ o ⨯ Nd ⨯ Nm \div B + L \qquad ( 8 )$$

$${Cost}_{FC , AlltoAll} = N ⨯ \frac{Nm - 1}{Nm} ⨯ o \div B + L \qquad ( 9 )$$

$${Cost}_{FC , gat her} = N ⨯ i ⨯ \frac{Nm - 1}{Nm} \div B + L \qquad ( 10 )$$

Here, Cost_{FC,allreduce} in the formula (8) represents the operation cost in the fully-coupled layer. Furthermore, Cost_{FC,AlltoAll} in the formula (9) represents the communication cost of the AlltoAll communication in a case where the fully-coupled layer is divided. Furthermore, Cost_{FC,gather} in the formula (10) represents a communication cost of Gather communication performed in a first stage of the fully-coupled layer. The cost calculation unit 14 assumes a sum of the communication cost of the AlltoAll communication in a case where the fully-coupled layer is divided and the communication cost of the data sharing (gather) communication performed in the first stage of the fully-coupled layer as the communication cost of the fully-coupled layer.

As described above, the cost calculation unit 14 calculates the communication cost and the operation cost caused by the communication occurred by performing division in the neural network that is caused to execute the learning processing. In a case where there is the plurality of candidates for the number of divisions that may be used in the entire neural network, the cost calculation unit 14 calculates a communication cost and an operation cost for each number of divisions. Then, the cost calculation unit 14 outputs the calculated communication cost and operation cost to the information provision unit 15.

The information provision unit 15 receives an input of the information regarding the division type and the number of divisions that may be used in each layer from the divisible layer extraction unit 12. Furthermore, the information provision unit 15 receives an input of the operation amount in each layer from the operation amount calculation unit 13. Moreover, the information provision unit 15 receives an input of the communication cost and the operation cost from the cost calculation unit 14. Then, the information provision unit 15 transmits and displays the information regarding the division type and the number of divisions that may be used in each layer, the operation amount in each layer, and the communication cost and the operation cost to and on a device such as the terminal device 3 so as to present the information to a designer of the neural network model. In a case where there is the plurality of candidates for the number of divisions that may be used in the entire neural network, the information provision unit 15 provides the information corresponding to each number of divisions to the designer.

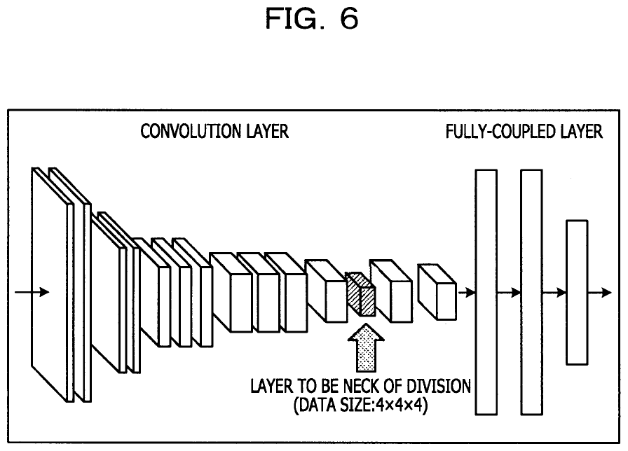

FIG. 6 is a diagram of an example of a notification screen of a layer to be a bottleneck of division. The information provision unit 15 specifies a layer with the smallest number of divisions that determines the total number of divisions, from among the number of divisions of each layer. Then, the information provision unit 15 may generate a screen, as illustrated in FIG. 6, in which the specified layer in the entire neural network model is highlighted as the layer to be the bottleneck of the division and present the screen to the designer of the neural network model.

The designer of the neural network model may select an appropriate parallel method and the number of parallels when learning is performed, on the basis of the presented information. For example, in a case where the designer considers that the number of parallels of a machine learning model is not sufficient, the designer increases the number of parallels in the neural network model by modifying the neural network model definition.

For example, by grasping the division type and the number of divisions that may be used in each layer, the designer may confirm which layer determines the number of divisions. For example, by using the screen as in FIG. 6, the designer may easily specify the layer to be the bottleneck of the division, easily change the neural network model definition to increase the number of divisions, and may easily improve an efficiency of the learning processing. Furthermore, the designer may select division that may execute the learning processing at higher speed by comparing an advantage of reducing an operation amount per calculation node 22 through division and a disadvantage of the communication cost and the operation cost to be added by division.

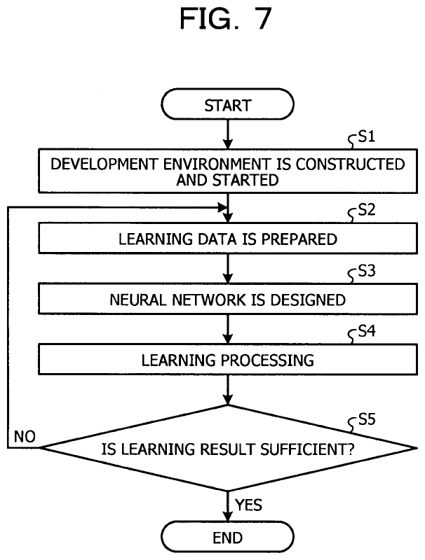

FIG. 7 is a flowchart of learning processing of deep learning using the model design assistance device according to the first embodiment. Next, with reference to FIG. 7, an entire flow of the learning processing of deep learning using the model design assistance device 1 according to the present embodiment will be described.

A development environment of the deep learning system is constructed and started (operation S1).

Learning data used to learn a neural network is prepared (operation S2).

The model design assistance device 1 presents the information regarding the division type and the number of divisions that may be used in each layer, the operation amount in each layer, and the communication cost and the operation cost to the designer using the information regarding the neural network model definition and the learning execution environment. The designer confirms the information presented from the model design assistance device 1 and designs a neural network model (operation S3).

A user inputs the information and a job regarding the designed neural network model to the deep learning system using the terminal device 3. Moreover, the user inputs the learning data into the deep learning system and makes the deep learning system execute the learning processing. The management node 21 arranges a job in the calculation node 22 on the basis of the input information regarding the neural network model and job. Then, the management node 21 inputs the learning data into each calculation node 22. The calculation node 22 executes the learning processing by executing a job designated for the learning data (operation S4).

Thereafter, the user inputs data for estimation into a trained neural network model and determines whether or not a learning result is sufficient (operation S5). In a case where learning accuracy is insufficient and the learning result is insufficient (operation S5: No), the learning processing returns to operation S2.

On the other hand, in a case where the learning accuracy reaches desired accuracy and the learning result is sufficient (operation S5: Yes), the learning processing ends.

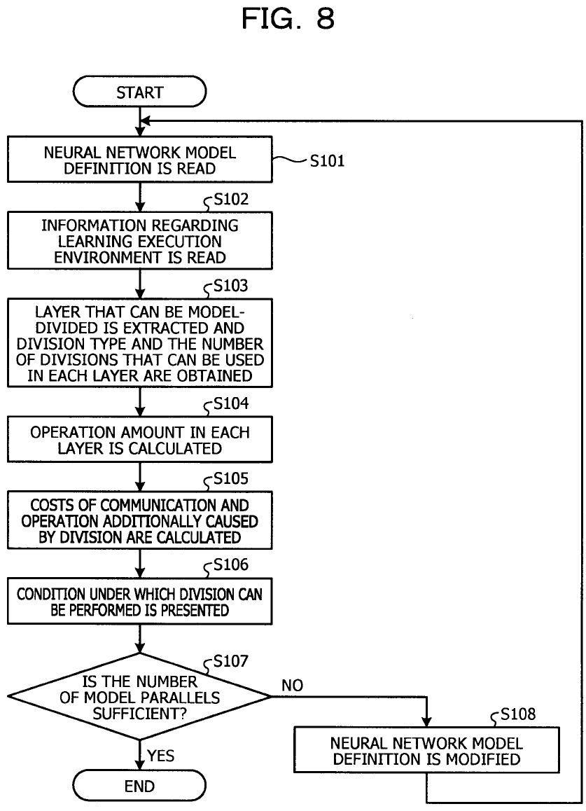

FIG. 8 is a flowchart of model design processing by the model design assistance device according to the first embodiment. Each processing illustrated in FIG. 8 corresponds to an example of the processing executed by the model design assistance device 1 in operation S3 in FIG. 7. Next, with reference to FIG. 8, a flow of the model design assistance processing by the model design assistance device 1 according to the present embodiment will be described.

The information acquisition unit 11 reads the neural network model definition (operation S101). Next, the information acquisition unit 11 reads learning environment information (operation S102). Then, the information acquisition unit 11 outputs the information regarding the neural network model definition and the learning execution environment to the divisible layer extraction unit 12.

The divisible layer extraction unit 12 extracts a layer that may be model-divided from the information regarding the neural network model definition and the learning execution environment and obtains the division type and the number of divisions that may be used in each layer (operation S103). For example, the divisible layer extraction unit 12 assumes the smaller size of input data and output data in a specific layer as a minimum unit of division and determines an upper limit of the number of divisions in the specific layer. Thereafter, the divisible layer extraction unit 12 fixes the number of divisions that may be used in the entire neural network model from among the numbers of divisions that may be used in each layer. Then, the divisible layer extraction unit 12 outputs the information regarding the division type that may be used in each layer and the number of divisions that may be used in the entire neural network model to the operation amount calculation unit 13 and the cost calculation unit 14. Furthermore, the divisible layer extraction unit 12 outputs the information regarding the division type and the number of divisions that may be used in each layer to the information provision unit 15.

The operation amount calculation unit 13 receives an input of the information regarding the division type that may be used in each layer and the number of divisions that may be used in the entire neural network model from the divisible layer extraction unit 12. Then, the operation amount calculation unit 13 calculates an operation amount per calculation node 22 in each layer (operation S104). Then, the operation amount calculation unit 13 outputs the calculated operation amount per calculation node 22 in each layer to the information provision unit 15.

Furthermore, the cost calculation unit 14 receives an input of the information regarding the division type that maybe used in each layer and the number of divisions that may be used in the entire neural network model from the divisible layer extraction unit 12. Then, the cost calculation unit 14 calculates communication and operation costs that are additionally caused through division (operation S105). For example, the cost calculation unit 14 calculates a communication cost caused by the communication in the sleeve region (Halo) used for operations, the data sharing (gather) communication between the two calculation nodes 22, and the communication in the processing of Allreduce. Furthermore, the cost calculation unit 14 calculates an operation cost caused in each layer. Thereafter, the cost calculation unit 14 outputs the calculated communication and operation costs to the information provision unit 15.

The information provision unit 15 receives an input of the information regarding the division type and the number of divisions that may be used in each layer from the divisible layer extraction unit 12. Furthermore, the information provision unit 15 receives an input of the operation amount in each layer from the operation amount calculation unit 13. Moreover, the information provision unit 15 receives an input of the communication cost and the operation cost from the cost calculation unit 14. Then, the information provision unit 15 transmits and displays the information regarding the division type and the number of divisions that may be used in each layer, the operation amount in each layer, and the communication cost and the operation cost to and on the device such as the terminal device 3. Furthermore, the information provision unit 15 presents information indicating the layer to the neck of the division to the designer. As a result, the information provision unit 15 presents a condition under which division may be performed to the designer of the neural network model (operation S106).

The designer confirms the condition under which division may be performed and determines whether or not the number of parallels of the machine learning model is sufficient with the presented division type and number of divisions (operation S107).

In a case where the number of model parallels is not sufficient (operation S107: No), the designer modifies the neural network model definition, for example, by changing a configuration of the layer to be the neck of the division on the basis of the presented information (operation S108). Thereafter, the designer inputs the modified neural network model definition into the model design assistance device 1 using an external information processing device or the like. Thereafter, the model design assistance processing returns to operation S101.

As described above, the model design assistance device according to the present embodiment obtains the division type and the number of divisions that may be used in each layer of the neural network that executes the learning processing, on the basis of the information regarding a model definition and the learning execution environment. Then, the model design assistance device presents the number of divisions that may be used in the entire neural network, the information regarding the layer to be the bottleneck of the division, the operation amount in each layer, and the communication cost and the operation cost added by the division to the designer.

As a result, the designer may easily grasp which division can be performed in the neural network and may select an appropriate parallel method and number of parallels when learning is performed, on the basis of the presented information. Furthermore, the designer may easily specify the layer to be the bottleneck of division and may easily change the neural network model definition to increase the number of divisions. For example, the designer may easily grasp how much the cost increases in what direction and how many divisions are made. Therefore, the designer may easily improve the efficiency of the learning processing. Furthermore, the designer may select division that may execute the learning processing at higher speed by comparing an advantage of reducing an operation amount per calculation node through division and a disadvantage of the communication cost and the operation cost to be added by division. Therefore, it is possible to facilitate the development of the neural network and accelerate the learning processing.

In the above description, the processing for determining the division type and the number of divisions and calculating the cost has been described mainly using the convolution layer as an example. However, a target layer is not limited to this. Each processing according to the present embodiment may be executed on the fully-coupled layer, and further, on a recurrent neural network (RNN) with the similar method.

Furthermore, in the present embodiment, in a case where the number of divisions is different for each layer, there is the calculation node 22 that is not used depending on a layer, and resources are wasted. Therefore, the model design assistance processing has been executed assuming that the number of divisions is the same across the entire neural network. However, in a case where waste of resources is not considered, it is possible to differ the number of divisions for each layer.

In this case, the operation amount calculation unit 13 obtains an operation amount for each number of divisions that may be used in each layer. Furthermore, the cost calculation unit 14 generates a combination of the numbers of divisions in the respective layers using the number of divisions that may be used in each layer and calculates a communication cost and an operation cost for each combination. The information provision unit 15 presents the operation amount, the communication cost, and the operation cost, for each combination of the numbers of divisions in the respective layers, to the designer.

### Second Embodiment

Next, a second embodiment will be described. A model design assistance device 1 according to the present embodiment is different from that according to the first embodiment in that a convolution layer is a target of model division and a fully-coupled layer is excluded from the target of the model division. The model design assistance device 1 according to the present embodiment is also illustrated in the block diagram in FIG. 1. In the following description, description of a function of each unit similar to that in the first embodiment will be omitted.

The fully-coupled layer is less likely to have advantages of model division than the convolution layer. Therefore, the model design assistance device 1 according to the present embodiment limits the target of the model division to the convolution layer. Hereinafter, details of an operation of the model design assistance device 1 according to the present embodiment will be described.

A divisible layer extraction unit 12 according to the present embodiment extracts a convolution layer from layers defined by a neural network model definition. Then, the divisible layer extraction unit 12 obtains a division type and the number of divisions that may be used for each extracted convolution layer. Moreover, the divisible layer extraction unit 12 obtains the number of divisions that may be used in the entire convolution layer.

An operation amount calculation unit 13 calculates an operation amount in the convolution layer using the division type that may be used in each convolution layer and the number of divisions that may be used in the entire convolution layer.

A cost calculation unit 14 calculates a communication cost and an operation cost that are additionally caused by division in the convolution layer using the division type that may be used in each convolution layer and the number of divisions that may be used in the entire convolution layer.

An information provision unit 15 notifies a designer of the operation amount, the communication cost and the operation cost that are additionally caused by the division, and a layer to be a bottleneck of the division in a case where the convolution layer is divided.

As described above, the model design assistance device according to the present embodiment limits the target of the model division to the convolution layer by excluding the fully-coupled layer that has less advantages of model division and provides various types of information in a case where division is performed to the designer. As a result, it is possible to suppress variation of divisions to be a small extent, suppress a calculation amount, reduce a processing load, and promptly provide the information. Furthermore, by suppressing the variation of divisions in the presented information to be a small extent, the designer may more easily select the division type and the number of divisions.

### Third Embodiment

Next, a third embodiment will be described. A model design assistance device 1 according to the present embodiment is also illustrated in the block diagram in FIG. 1. The model design assistance device 1 according to the present embodiment is different from that according to the first embodiment in that calculation nodes 22 are connected to each other via a plurality of networks in a deep learning system to be a target of model design. In the following description, description of an operation of each unit similar to that in the first embodiment will be omitted.

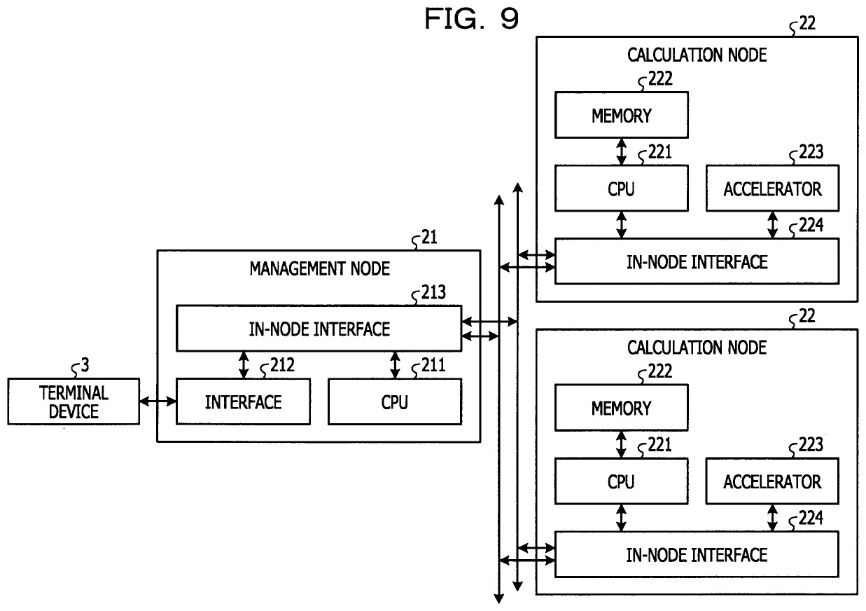

FIG. 9 is a diagram illustrating an example of an information processing system in which a deep neural network according to the third embodiment operates. In the information processing system according to the present embodiment, a management node 21 and each of calculation nodes 22 are connected via a plurality of inter-node high-speed networks. Here, the plurality of inter-node high-speed networks that connects between the calculation nodes 22 may be a plurality of physical networks, a virtually-divided network, or a network obtained by dividing a network having a plurality of dimensions in a form where arbitrary dimensions are allocated. The calculation nodes 22 may perform communications different from each other in parallel using different inter-node high-speed networks.

Then, the calculation node 22 uses the different inter-node high-speed networks respectively for communication performed in a model parallel and communication performed in Allreduce. As a result, the calculation node 22 may proceed two types of communications used in learning processing using the different inter-node high-speed networks and may accelerate the learning processing.

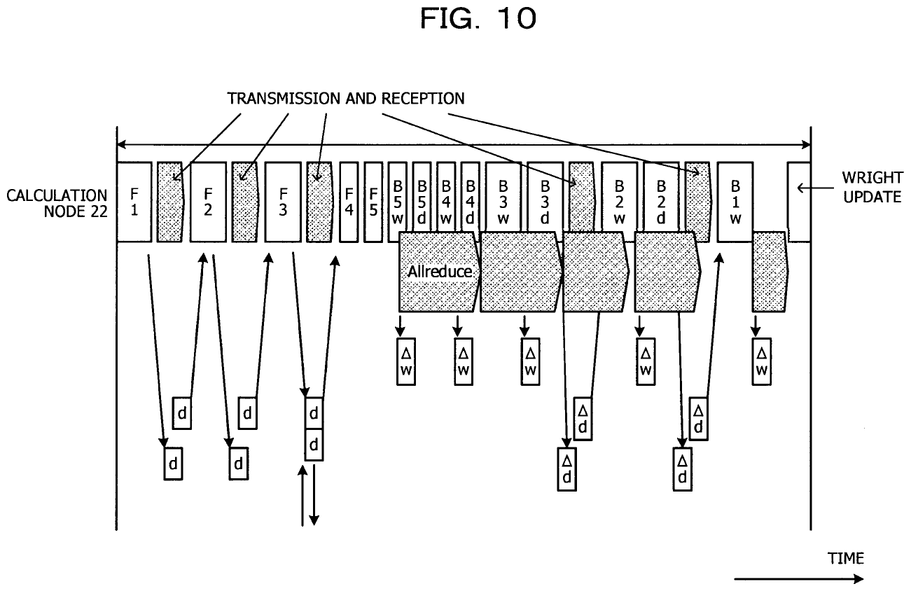

FIG. 10 is a diagram illustrating an example of communication occurred in learning processing in a case where parallel processing is executed in the third embodiment. In FIG. 10, the vertical axis represents the calculation node 22, and the horizontal axis represents passage of time. The calculation node 22 executes Allreduce processing on gradient information represented by Aw each time when a weight parameter is calculated in backward processing in each layer. In this case, because the communication in the model parallel and the communication in Allreduce respectively use the different inter-node high-speed networks, the calculation node 22 may proceed the learning processing at high speed without making the communication associated with model parallel wait, as illustrated in FIG. 10. Here, in FIG. 10, weight update processing is executed at the time when Allreduce in a final layer is completed. However, the embodiment is not limited to this, and the weight update processing may be executed, for example, each time when each Allreduce is completed.

In the present embodiment, because the backward processing and the Allreduce processing are executed in parallel, it may be considered that a cost for one of the two types of processing executed in parallel is reduced. Therefore, the cost calculation unit 14 according to the present embodiment subtracts an operation cost for backward from a cost caused in Allreduce except for the final stage. For example, the cost calculation unit 14 calculates a communication cost of Allreduce using the following formula (11).

$${Cost}_{allreduce} = max ( 0 , {\sum }_{L : Other than final layer} {Cost}_{L , allreduce} - \frac{2}{3} \sum {Cost}_{calc} ) + {Cost}_{Final layer , allreduce} \qquad ( 11 )$$

Here, L represents a layer other than the final layer, and Cost_{L,allreduce} represents a communication cost of Allreduce for the layer other than the final layer. Furthermore, Cost_{final layer,allreduce} represents a communication cost of Allreduce for the final layer.

The cost calculation unit 14 assumes a sum of the calculated communication cost of Allreduce and a communication cost for transmission and reception in a sleeve region as a communication cost in a convolution layer.

As described above, the model design assistance device according to the present embodiment may calculate the communication cost under a condition in which the communication associated with the model parallel and the communication of Allreduce are performed in parallel. As a result, an appropriate communication cost may be calculated even in a case where the calculation nodes, which perform deep learning, are connected via the two networks, and appropriate information according to a system configuration may be provided to a designer of a neural network model. Therefore, the designer may more easily design an appropriate neural network model according to the system configuration.

### Fourth Embodiment

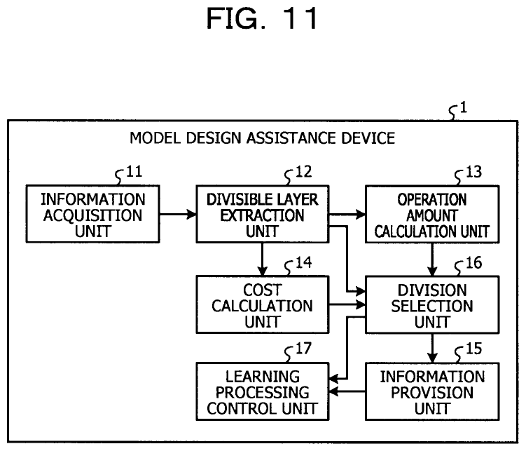

FIG. 11 is a block diagram of a model design assistance device according to a fourth embodiment. As illustrated in FIG. 11, a model design assistance device 1 according to the present embodiment includes a division selection unit 16 and a learning processing control unit 17 in addition to each unit described in the first embodiment.

The model design assistance device 1 according to the present embodiment is different from that according to the first embodiment in that an operation amount, a communication cost, and an operation cost are quantitatively evaluated, a division type and the number of divisions used in each layer are automatically selected, and learning processing is executed using the selected division type and number of divisions. In this case, the model design assistance device 1 may have the function of the terminal device 3 in FIG. 2. In the following description, description of an operation of each unit similar to that in the first embodiment will be omitted.

The division selection unit 16 receives an input of information regarding the division type and the number of divisions that may be used in each layer from a divisible layer extraction unit 12. Furthermore, the division selection unit 16 receives an input of the operation amount in each layer from an operation amount calculation unit 13. Moreover, the division selection unit 16 receives an input of the communication cost and the operation cost from a cost calculation unit 14.

Next, the division selection unit 16 selects the division type that may be used in each layer, compares and quantitatively evaluates a communication amount after division and the communication cost and the operation cost increased through the division, for each combination of the division types in the respective layers. Here, in a case where there is a plurality of candidates for the number of divisions, the division selection unit 16 similarly evaluates each number of divisions. Then, the division selection unit 16 selects a combination of the division types in the respective layers with which a learning processing efficiency is the highest and determines the selected combination as division with which a learning efficiency is the highest. The division with which the learning efficiency is the highest is division in which a communication cost and an operation cost caused when deep learning is performed are reduced as possible, on the basis of the operation amount and the communication cost and the operation cost increased through the division. Then, the division selection unit 16 outputs information regarding the selected division with which the learning processing efficiency is the highest to the learning processing control unit 17.

For example, the division selection unit 16 calculates a communication amount in a case where division is not performed and subtracts a communication amount after the division so as to calculate a communication amount reduced through the division. Then, the division selection unit 16 assumes a calculation result obtained by subtracting a value obtained by normalizing the communication amount reduced through the division from a normalized sum of the communication cost and the operation cost as the learning processing efficiency. In this case, it may be said that the smaller a value of the calculation result, the higher the learning processing efficiency. Then, the division selection unit 16 selects a combination of the division types in the respective layers with which the learning processing efficiency is the highest from among the combinations of the division types used in the respective layers and outputs the selected combination to the learning processing control unit 17.

Furthermore, the division selection unit 16 selects a predetermined number of divisions with a high learning processing efficiency including the division with which the learning processing efficiency is the highest. Then, the division selection unit 16 outputs information regarding the selected division with which the learning processing efficiency is high to the information provision unit 15. Here, the information regarding the division with which the learning processing efficiency is high may include, for example, the division type and the number of divisions in each layer, the operation amount, and the communication cost and the operation cost.

For example, the division selection unit 16 extracts a predetermined number of combinations in descending order of the learning processing efficiency and assumes the combination as the division with which the learning processing efficiency is high. Here, in a case where there is a plurality of candidates for the number of divisions, the division selection unit 16 similarly extracts a predetermined number of divisions with which the learning processing efficiency is high for each number of divisions.

The information provision unit 15 acquires the information regarding the division with which the learning processing efficiency is high from the division selection unit 16. Then, the information provision unit 15 provides information regarding the division with which the learning processing efficiency is high to the designer of the neural network model. Thereafter, in a case of receiving an input of the information regarding the division selected by the designer from among the divisions of which the information has been provided, the information provision unit 15 outputs the information regarding the selected division to the learning processing control unit 17.

The learning processing control unit 17 receives an input of information regarding the division with which the learning processing efficiency is the highest from the division selection unit 16. Then, if there is no input of the information regarding the division selected by the designer from the information provision unit 15, the learning processing control unit 17 designs a neural network model using the division with which the learning processing efficiency is the highest. Then, the learning processing control unit 17 transmits the designed neural network model to the management node 21 and causes the calculation node 22 to execute the learning processing using the division with which the learning processing efficiency is the highest.

On the other hand, in a case where the information regarding the division selected by the designer is input from the information provision unit 15, the learning processing control unit 17 designs a neural network model using the division selected by the designer. Then, the learning processing control unit 17 transmits the designed neural network model to the management node 21 and cause the calculation node 22 to execute the learning processing using the division selected by the designer.

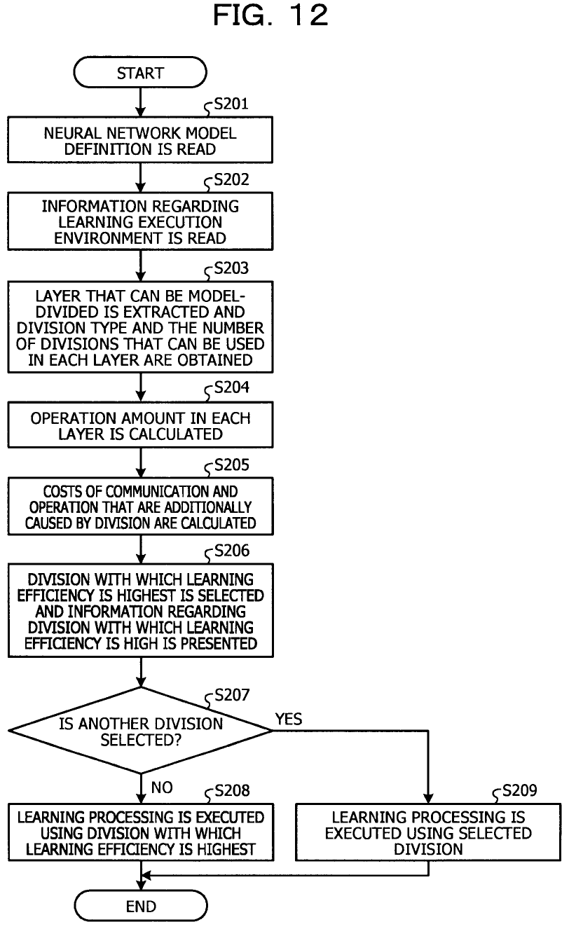

FIG. 12 is a flowchart of model design assistance processing by the model design assistance device according to the fourth embodiment. Next, with reference to FIG. 12, a flow of the model design assistance processing by the model design assistance device 1 according to the present embodiment will be described.

The information acquisition unit 11 reads a neural network model definition (operation S201). Next, the information acquisition unit 11 reads learning environment information (operation S202). Then, the information acquisition unit 11 outputs the information regarding the neural network model definition and the learning execution environment to the divisible layer extraction unit 12.

The divisible layer extraction unit 12 extracts a layer that may be model-divided from the information regarding the neural network model definition and the learning execution environment and obtains the division type and the number of divisions that may be used in each layer (operation S203). Then, the divisible layer extraction unit 12 outputs the information regarding the division type that may be used in each layer and the number of divisions that may be used in the entire neural network model to the operation amount calculation unit 13 and the cost calculation unit 14. Furthermore, the divisible layer extraction unit 12 outputs the information regarding the division type and the number of divisions that may be used in each layer to the division selection unit 16.

The operation amount calculation unit 13 receives an input of the information regarding the division type that may be used in each layer and the number of divisions that may be used in the entire neural network model from the divisible layer extraction unit 12. Then, the operation amount calculation unit 13 calculates an operation amount in each layer (operation S204). Then, the operation amount calculation unit 13 outputs the calculated operation amount in each layer to the division selection unit 16.

Furthermore, the cost calculation unit 14 receives an input of the information regarding the division type that may be used in each layer and the number of divisions that may be used in the entire neural network model from the divisible layer extraction unit 12. Then, the cost calculation unit 14 calculates communication and operation costs that are additionally caused through division (operation S205). Thereafter, the cost calculation unit 14 outputs the calculated communication and operation costs to the division selection unit 16.

The division selection unit 16 receives an input of information regarding the division type and the number of divisions that may be used in each layer from a divisible layer extraction unit 12. Furthermore, the division selection unit 16 receives an input of the operation amount in each layer from an operation amount calculation unit 13. Moreover, the division selection unit 16 receives an input of the communication cost and the operation cost from a cost calculation unit 14. Then, the division selection unit 16 compares the communication amount after division and the communication cost and the operation cost increased through division and quantitatively evaluates the communication amount and the communication cost and the operation cost for each combination of the division types in the respective layers. Then, the division selection unit 16 selects a combination of the division types in the respective layers with which the learning processing efficiency is the highest and determines the selected combination as division with which the learning processing efficiency is the highest. Then, the division selection unit 16 outputs information regarding the selected division with which the learning processing efficiency is the highest to the learning processing control unit 17. Furthermore, the division selection unit 16 selects a predetermined number of divisions with a high learning processing efficiency including the division with which the learning processing efficiency is the highest. Then, the division selection unit 16 outputs information regarding the selected division with which the learning processing efficiency is high to the information provision unit 15. The information provision unit 15 presents information regarding the division with which the learning processing efficiency is high to the designer of the neural network model (operation S206).

In a case of selecting division other than the division with which the learning processing efficiency is the highest from among the presented divisions with which the learning processing efficiency is high, the designer inputs information regarding the selected division into the information provision unit 15. When receiving the input of the information regarding the division selected by the designer, the information provision unit 15 outputs the information to the learning processing control unit 17. The learning processing control unit 17 determines whether or not another division is selected according to whether or not the information regarding the division selected by the designer is input (operation S207).

In a case where the another division is not selected (operation S207: No), the learning processing control unit 17 designs a neural network model using the division with which the learning processing efficiency is the highest. Then, the learning processing control unit 17 transmits the designed neural network model to the management node 21 and causes the calculation node 22 to execute the learning processing using the division with which the learning processing efficiency is the highest (operation S208).

On the other hand, in a case where the another division is selected (operation S207: Yes), the learning processing control unit 17 designs a neural network model using the division selected by the designer. Then, the learning processing control unit 17 transmits the designed neural network model to the management node 21 and causes the calculation node 22 to execute the learning processing using the division selected by the designer (operation S209).

As described above, the model design assistance device according to the present embodiment quantitatively evaluates the operation amount reduced through the division and the communication cost and the operation cost increased through the division and specifies the division with which the learning processing efficiency is high. Then, the model design assistance device executes the learning processing using the division with which the learning processing efficiency is the highest if the designer does not select the another division and executes the learning processing using the selected division in a case where the designer selects the another division.

As a result, the model design assistance device may execute the learning processing using the neural network designed using the division determined to have the highest learning processing efficiency and may execute the learning processing with the division method and the number of divisions that may be performed at high speed and reduce cost. Therefore, it is possible to facilitate the development of the neural network and accelerate the learning processing.

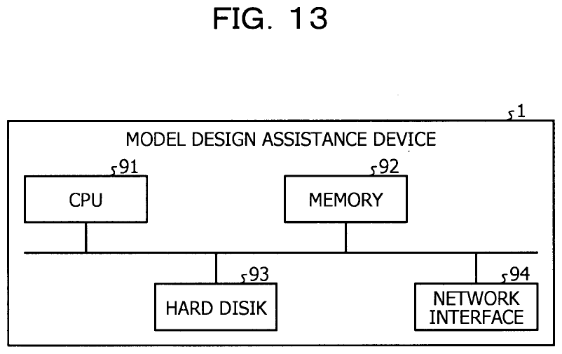

FIG. 13 is a hardware configuration diagram of the model design assistance device. Next, with reference to FIG. 13, a hardware configuration of the model design assistance device 1 described in each of the above embodiments will be described.

The model design assistance device 1 includes, for example, a CPU 91, a memory 92, a hard disk 93, and a network interface 94. The CPU 91 is connected to the memory 92, the hard disk 93, and the network interface 94 via a bus.

The network interface 94 is an interface for communication between the model design assistance device 1 and an external device. For example, the network interface 94 relays communication between the CPU 91 and the terminal device 3.

The hard disk 93 is an auxiliary storage device. The hard disk 93 stores various programs including programs for implementing functions of the information acquisition unit 11, the divisible layer extraction unit 12, the operation amount calculation unit 13, the cost calculation unit 14, the information provision unit 15, the division selection unit 16, and the learning processing control unit 17.

The CPU 91 reads various programs stored in the hard disk 93, develops the programs on the memory 92, and executes the programs. As a result, the CPU 91 implements the functions of the information acquisition unit 11, the divisible layer extraction unit 12, the operation amount calculation unit 13, the cost calculation unit 14, the information provision unit 15, the division selection unit 16, and the learning processing control unit 17.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a learning program for causing a computer to execute a procedure, the procedure comprising:
extracting a divisible layer among a plurality of layers included in a machine learning model, based on a definition of the machine learning model and information regarding a machine learning execution environment that includes information regarding a plurality of calculation nodes that performs machine learning by using the machine learning model, and determining a division type and a number of divisions that are available in each extracted divisible layer;
obtaining an operation amount for each of the calculation nodes, based on the division type and the number of divisions;
obtaining a communication cost and an operation cost of the machine learning model after division of the divisible layer, based on the division type and the number of divisions; and
presenting the operation amount, the communication cost, and the operation cost.

2. The non-transitory computer-readable recording medium according to claim 1, wherein
the machine learning model is a model of a convolution neural network, and
a convolution layer in the machine learning model is extracted as the divisible layer.

3. The non-transitory computer-readable recording medium according to claim 1, the procedure further comprising:
selecting the division type in each divisible layer with a minimum communication cost and operation cost when the machine learning is performed, based on the operation amount, the communication cost, and the operation cost; and
designing the machine learning model by using the determined number of divisions and the selected division type in each divisible layer, and causing the plurality of calculation nodes to perform the machine learning by using the designed machine learning model.

4. The non-transitory computer-readable recording medium according to claim 1, wherein
first number of divisions that is available in an entire machine learning model is determined, based on the number of divisions that is available in each extracted divisible layer,
the operation amount is obtained, based on the first number of divisions, and
the communication cost and the operation cost are obtained, based on the first number of divisions.

5. The non-transitory computer-readable recording medium according to claim 4, wherein the procedure presents a notification screen that represents the divisible layer to be a bottleneck to increase the first number of divisions in each divisible layer of the machine learning model.

6. The non-transitory computer-readable recording medium according to claim 1, wherein
the calculation nodes are coupled respectively via two different networks, and
the communication cost and the operation cost, in a case where parallel processing is executed by using each of the two networks in the machine learning, are obtained.

7. A learning method comprising:
extracting a divisible layer among a plurality of layers included in a machine learning model, based on a definition of the machine learning model and information regarding a machine learning execution environment that includes information regarding a plurality of calculation nodes that performs machine learning by using the machine learning model, and determining a division type and a number of divisions that are available in each extracted divisible layer;
obtaining an operation amount for each of the calculation nodes, based on the division type and the number of divisions;
obtaining a communication cost and an operation cost of the machine learning model after division of the divisible layer, based on the division type and the number of divisions; and
presenting the operation amount, the communication cost, and the operation cost, by a processor.

8. An information processing device comprising:
a memory; and
a processor coupled to the memory and configured to:
extract a divisible layer among a plurality of layers included in a machine learning model, based on a definition of the machine learning model and information regarding a machine learning execution environment that includes information regarding a plurality of calculation nodes that performs machine learning by using the machine learning model, and determine a division type and a number of divisions that are available in each extracted divisible layer;
obtain an operation amount for each of the calculation nodes, based on the division type and the number of divisions;
obtain a communication cost and an operation cost of the machine learning model after division of the divisible layer, based on the division type and the number of divisions; and
present the operation amount, the communication cost, and the operation cost.
